(19) United States
(12) Patent Application Publication
(10) Pub. No.: US 2003/0169896 A1
(43) Pub. Date: Sep. 11, 2003

(54) Ear clip speakers that interlock and enable cord spooling

(76) Inventors: Karl Dallas Kirk III, New York, NY (US); William Fiebel, Clifton, NJ (US); Anna Stern, Stockholm (SE)

Correspondence Address: COBRIN & GITTES, 750 LEXINGTON AVENUE, 21ST FLOOR, NEW YORK, NY, 10022, US

(21) Appl. No.: 10/090,720

(22) Filed: Mar. 5, 2002

(51) Int. Cl. H04R 1/00; H04R 9/06; H04R 11/02; H04R 25/00

(52) U.S. Cl. 381/370; 381/384

(57) ABSTRACT

A structure and method of arrangement for use in audio playback that includes a pair of speakers each having a housing and fasteners, which may cooperate to provide a convex configuration. The fasteners include two spring biased fasteners that are configured to retract simultaneously in each of the housings. Once they are retracted simultaneously, the housings may be twisted relative to each other to lock the speakers together through engagement of two fixed fasteners and through spring bias from the two spring biased fasteners. An audio cord or wire of the speakers may then be spooled about a junction formed where the fixed fasteners overlap each other to effect the engagement.

### BACKGROUND OF THE INVENTION

1. Field of the Invention

The invention relates to ear clip speakers that interlock with each other. Audio cords of the speakers may be spooled about the location where the speakers interlock.

2. Discussion of Related Art

Conventional ear clip speakers are distributed to passengers on commercial aircraft to enable the passengers access to audio ports in the arm rests of their seats for listening to the aircraft internal audio playback system.

The present inventors have observed that the two speakers in a pair of ear clip speakers do not need to be separate from each other when not in use, such as during periods of storage. Further, there is no need to all the audio cords of the speakers to freely dangle when the pair of ear clip speakers are not in use.

It is therefore desired to modify conventional ear clip speakers so as to enable the speakers to no longer remain separate from each other when not in use and to enable their audio cords to no longer dangle freely when the speakers are not in use.

### BRIEF SUMMARY OF THE INVENTION

One aspect of the invention resides in a pair of ear clip speakers each with a speaker housing that has a spring biased fastener and a fixed fastener. When the fasteners of one of the speakers are brought into engagement and alignment with the fasteners of the other of the speakers, further manual pressing results in retraction of two of the fasteners in opposite directions. With the two of the fasteners retracted, twisting the speakers relative to each other by rotation in one direction causes another two of the fasteners to overlap and locks the speakers together at a junction where the two fasteners overlap. If the two fasteners that retract are spring biased, the spring bias from each is in opposite directions that tend to keep the fixed fasteners overlapped until untwisted by manual force. By twisting the speakers to rotate in a reverse direction, the speakers become unlocked from each other to enable the springs to spring bias the speakers apart from each other and out of engagement.

Each housing may have a convex face whose contour is partially defined by an outermost surface of the associated ones of the fasteners while the speakers are in an unlocked condition. Each housing has an opposite side that is padded and is of a dimension greater than that of the junction about which the audio cord is spooled or wrapped when the speakers are locked.

### BRIEF DESCRIPTION OF THE SEVERAL VIEWS OF THE DRAWING

For a better understanding of the present invention, reference is made to the following description and accompanying drawings, while the scope of the invention is set forth in the appended claims.

FIG. 1 shows a perspective view of a pair of right and left ear clip speakers that interlock in accordance with the invention.

FIGS. 2-5 show progressive side views of the pair of the right and left ear clip speakers that interlock of FIG. 1, in which FIG. 2 shows contact between the convex faces,

FIG. 3 shows engagement of the convex faces, FIG. 4 shows interlocking of the convex faces after relative turning, and FIG. 5 shows the audio cord of the right and left ear clip speakers spooled.

FIG. 6 shows a schematic perspective view of a left ear clip speaker of FIGS. 1-5 after engagement with the right speaker, showing a spring biased fastener pressed in against spring bias.

FIG. 7 shows a schematic perspective view of the right ear clip speaker of FIGS. 1-5 after engagement with the left speaker, showing another spring biased fastener pressed in against spring bias.

FIG. 8 shows a schematic representation showing the locking engagement of the left and right ear clip speakers.

FIGS. 9 and 10 show exploded front and rear perspective views of the right ear clip speaker of FIGS. 1-5.

FIGS. 11 and 12 show exploded front and rear perspective views of the left ear clip speaker of FIGS. 1-5.

### DETAILED DESCRIPTION OF THE INVENTION

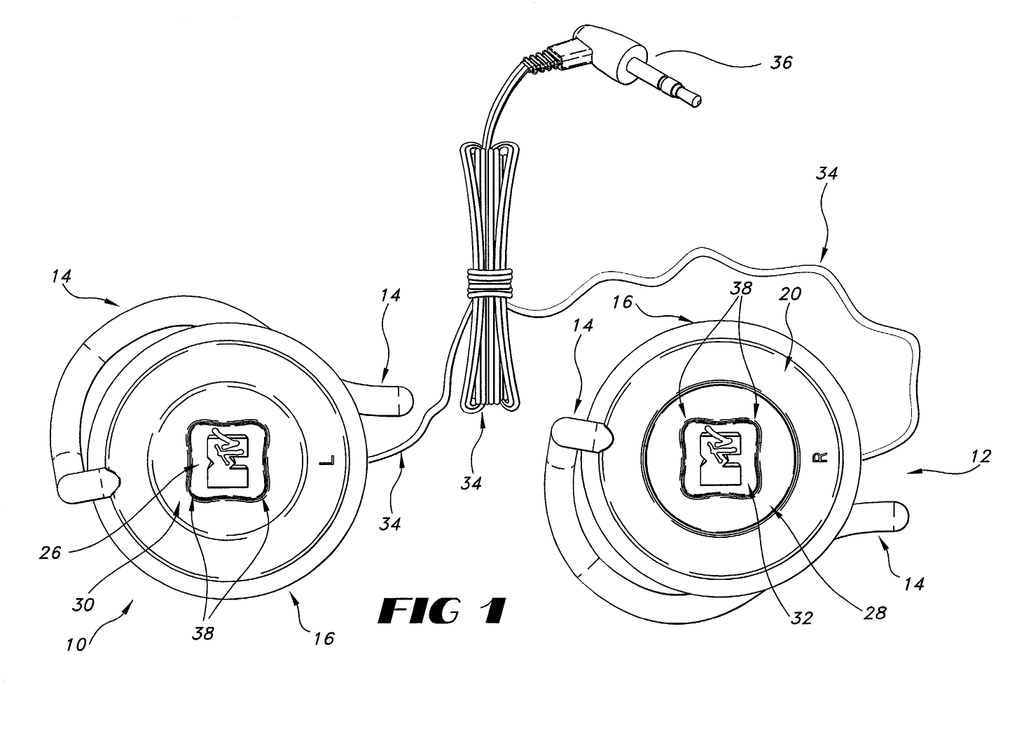

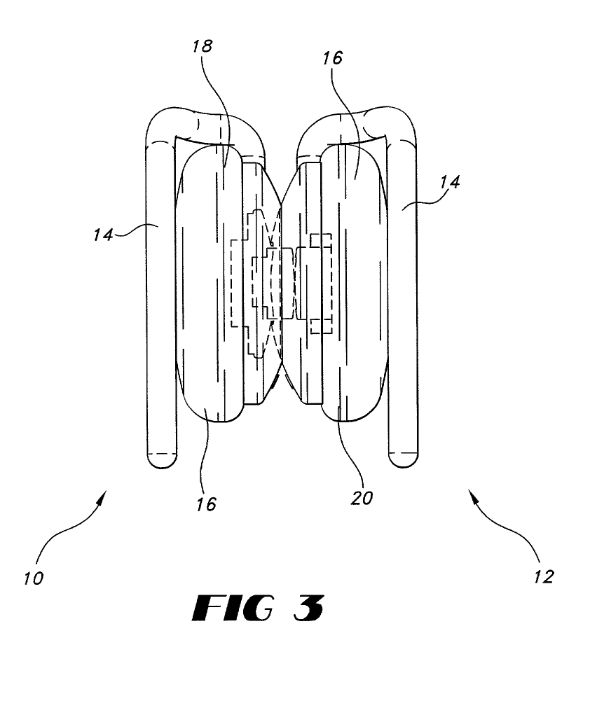

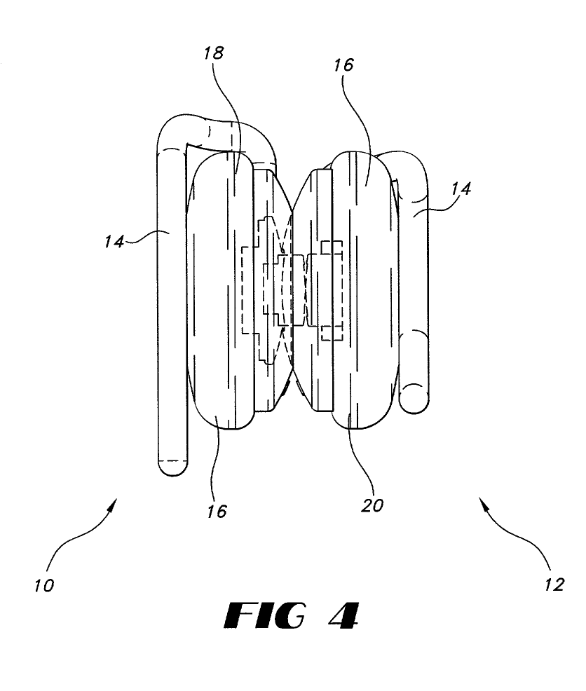

Turning to the drawings of FIGS. 1-7, a left ear clip speaker 10 and a right ear clip speaker 12 are shown, each having their own conventional flexible ear hook 14 and conventional padding 16. Each has a respective housing 18, 20 that houses conventional speaker electronics, perhaps within a sub-housing (not shown). The padding 16 is secured to an inner face of the respective housing 18, 20. The outer convex faces 22, 24 of the housings 18, 20 are convex in configuration and each has a complementary one of spring biased fasteners 26, 28 and a complementary one of the fixed fasteners 30, 32. Conventional audio cord or wire 34 extends from each speaker with a conventional terminal 36 configured to be inserted into a conventional audio port (not shown) to enable playback of audio signals, after being transformed into sounds by the speaker electronics through the ear clip speakers 10,12.

The ear clip speakers 10,12 may be locked together by engaging the spring biased fasteners 26, 28 with the fixed fasteners 30, 32. This may be accomplished by aligning the spring biased fastener 26 and fixed fastener 30 of the left speaker 10 with their counterpart fasteners 28, 32 of the right speaker 12, pressing the outer convex faces 22, 24 toward each other against the spring bias of the spring biased fasteners 26,28 while maintaining the alignment, and, after pressing in as far as possible, twisting the outer convex faces 22, 24 relative to each other in one direction such as clockwise so as to interlock the fasteners 26, 28, 30, 32.

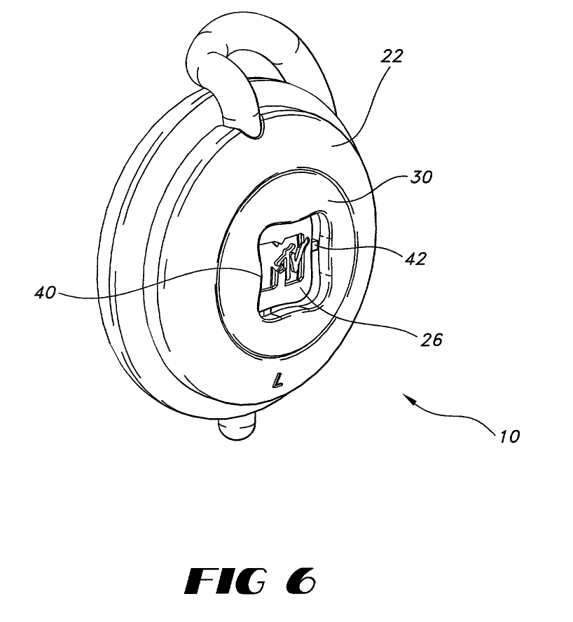

The shape of the edges of the spring biased fasteners 26, 28 conform to the shape of the edges of the fixed fasteners 30, 32. Fasteners 26, 32 preferably have corners 38. During twisting, the corners 38 of fixed fastener 32 are moved behind the underside of the fixed fastener 30 into a locking position while the spring biased fasteners 26, 28 remain in a compressed condition. The fixed fastener 30, which defines a square edge at its opening 40, may have blocking elements 42 (FIG. 6) that block the corners 38 of fixed fastener 32 and thereby block rotation beyond a quarter turn. These blocking elements 42 extend from the underside of the convex surface of the fixed fastener 30 in succession along one side adjacent each corner of the square edge. Thus, the sides adjacent to the blocking elements 42 at each corner remain clear.

Further, the spring biased fastener 26 presses against the fixed fastener 32 in a direction opposite to the direction that the spring biased fastener 28 presses against the fixed fastener 30. Once the left and right speakers 10,12 are locked together, the audio cord or wire 34 may be spooled or wrapped around the junction between the left and right speakers 10,12 to provide a neat appearance and avoid leaving the audio cord or wire 34 dangling in a loose manner by its full length.

To unlock the speakers 10,12 from each other, the reverse order of steps involved in locking them is followed. That is, the sequence of steps for locking involves aligning the complementary fasteners 26, 28, 30, 32, pressing the outer convex faces 22, 24 of the housings 18, 20 toward each other against spring bias as far as possible and then twisting the housings 18, 20 in one direction relative to each other. The sequence of steps for unlocking involves twisting the housings 18, 20 in a direction reverse to the one direction relative to each other, allowing the spring bias to push the outer convex faces 22, 24 out of engagement and away from each other and then separating the speakers 10, 12 from each other. If the audio cord or wire 34 had been spooled when the speakers 10, 12 were locked together, then unlocking the speakers 10, 12 from each other and separating them still provides the user with the benefit of having the audio cord or wire 34 in the wrapped condition if held in that position immediately upon separation of the speakers 10, 12.

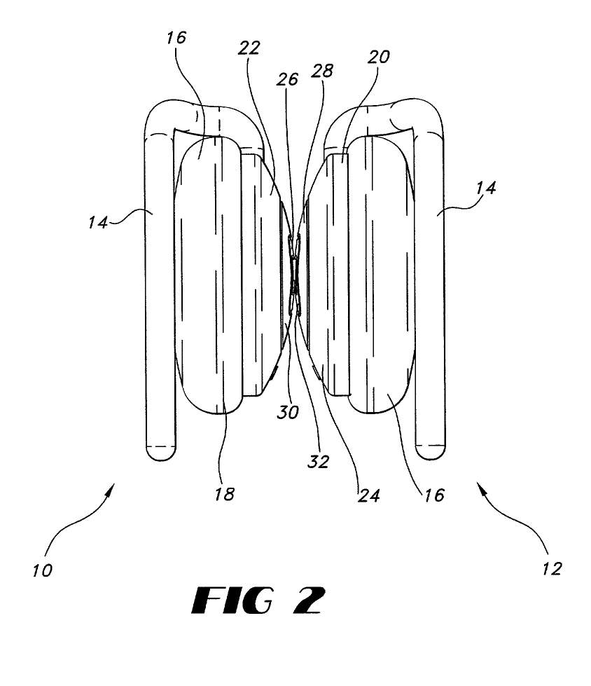

For ease in understanding, FIG. 1 shows a perspective view of the pair of speakers 10, 12 prior to engagement, with the audio cord or wire 34 shown dangling. FIGS. 2-4 illustrate the locking procedure in succession, i.e., alignment, engagement and twisting rotation.

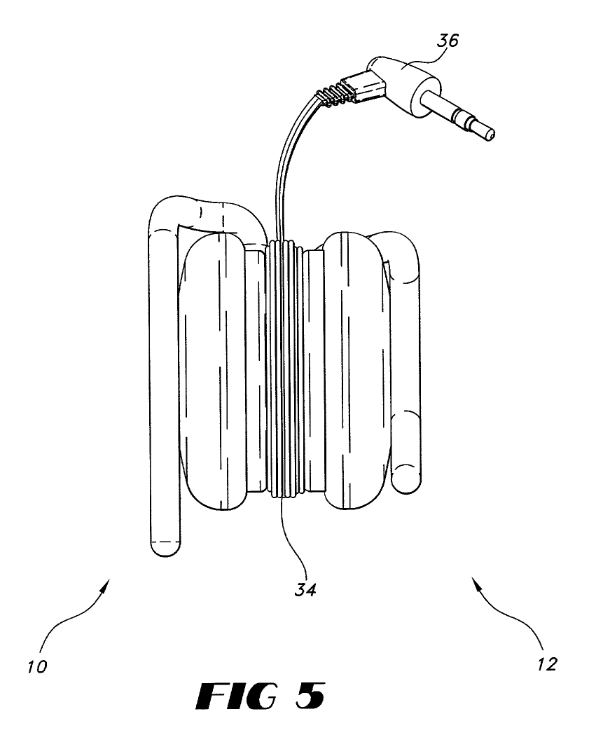

FIG. 5 shows spooling the audio cord or wire 34 about the junction where the convex faces 22, 24 are interlocked by the complementary fasteners. The dimension of the junction is smaller than the dimension of the padding 16 and the largest dimension of each of the speakers. Such a configuration enables spooling.

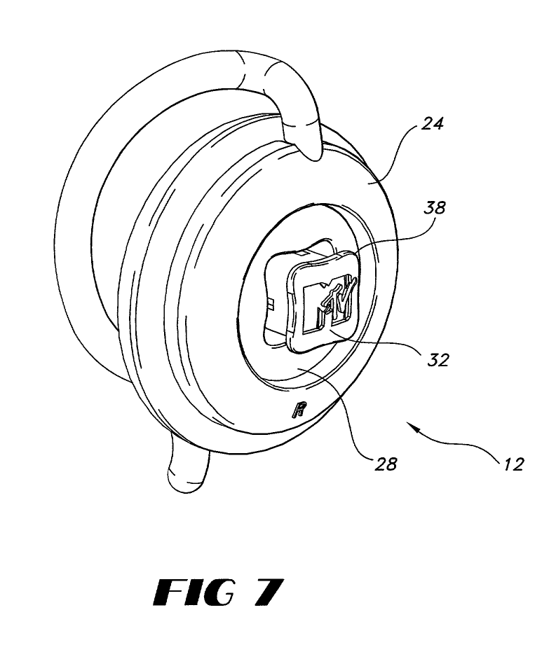

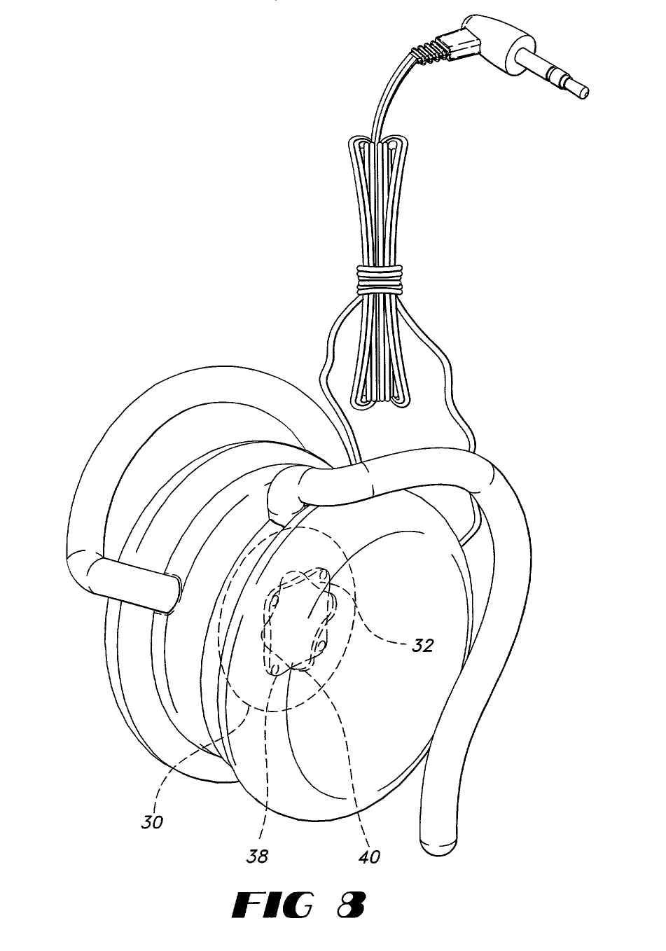

FIGS. 6 and 7 show representative internal views of the speakers 10, 12 to illustrate the spring biasing action using springs 44. FIG. 8 represents the manner in which the fasteners 30, 32 interlock under the spring bias at fasteners 26, 28. The view shows the top of fixed fastener 32 after it has protruded through the opening 40 in the fixed fastener 30 and is twisted relative to the fixed fastener 30. Blocking elements 40 only permit a quarter turn.

By providing the two central fasteners 26, 32 with corners 38, the fixed one of the two central fasteners 32 will have its corners 38 lodge or wedge behind the underside of the outer one of the fixed fasteners 30 due to spring bias exerted in opposite directions by the central fastener 26 against the central fastener 32 and by the outer fastener 28 against the outer fastener 30. The thickness of the fixed fasteners 30, 32 should be such as to enable the fixed fastener 32 to clear the thickness of the fixed fastener 30 when the spring biased fasteners 26, 28 are at most in the fully compressed conditions so as to enable relative twisting thereafter to effect the locking.

As should be evident from the drawings, the outward face of the spring biased fasteners 26, 28 each define a portion of a contour of the convex configuration of the respective housing while in a fully extended position, i.e, with the spring biased fasteners in a relaxed condition. When in a fully retracted position, however, each outward face leaves a recess in the convex configuration, i.e., with the spring biased fasteners in a compressed condition.

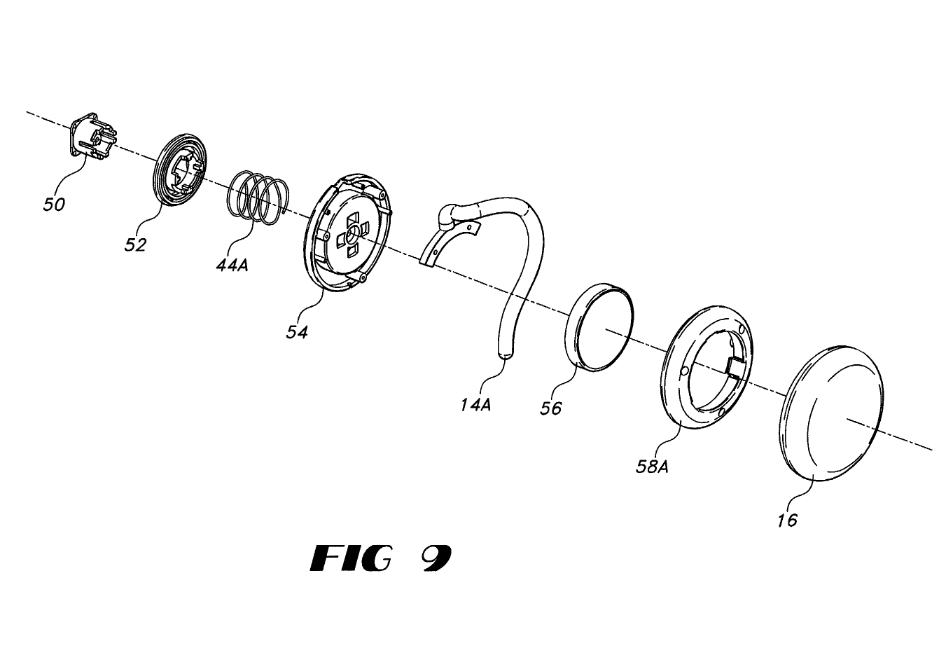

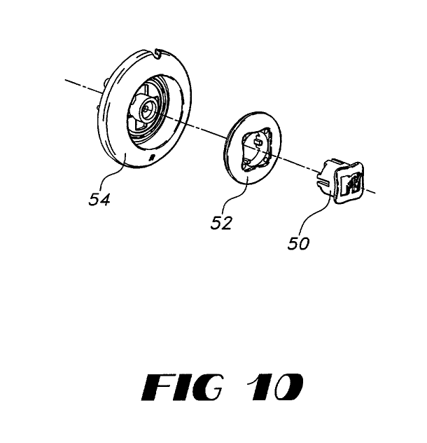

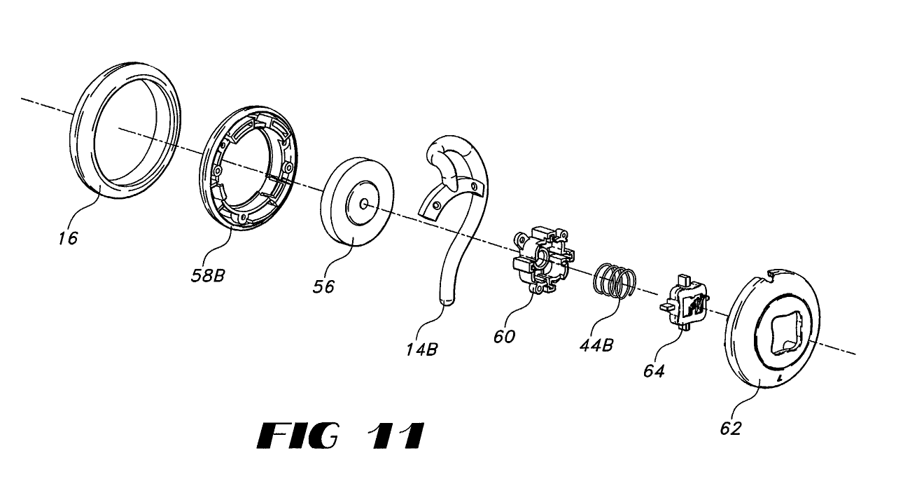

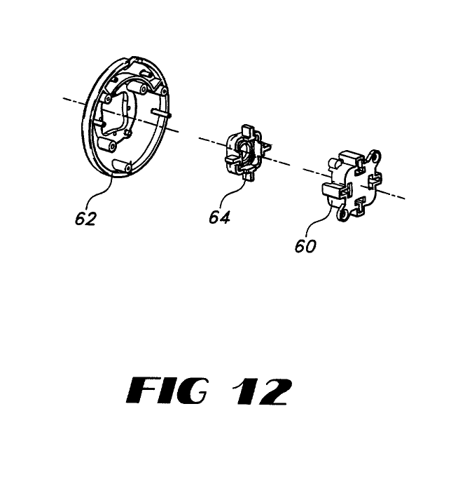

FIGS. 9 and 10 show the assembly of the right ear clip speaker and FIGS. 11 and 12 show the assembly of the left ear clip speaker. FIGS. 9-10 show a logo piece 50, a floating ring 52, a spring 44A, a cover 54, an ear hook 14A, a speaker driver 56, a speaker ring 58A and the padding 16 (foam ear pad). FIGS. 11-12 show the padding 16 (foam ear pad), speaker ring 58B, ear hook 14B, chassis 60, cover 62, spring 44B, and logo piece 64. The logo pieces 50, 66 may have an advertising logo or other indicia on them.

To avoid duplication, FIG. 10 only depicts the opposite side of those components of FIG. 9 that are not evident from FIG. 11 for the same components. FIG. 12 also only shows the opposite side of those components whose opposite side is not depicted elsewhere. The left and right ear clip speakers' ear hooks 14A, 14B, and the left and right ear clip speakers' speaker rings 58A, 58B mirror each other. The padding 16 and the speaker drivers 56 are the same construction for the left and right ear clip speakers.

For ease in understanding the terminology of the application, the logo piece 64 of FIGS. 11 and 12 is part of the spring biased fastener 26 of FIG. 6. The floating ring 52 of FIGS. 9 and 10 is part of the spring biased fastener 28 of FIG. 7. The logo piece 50 of FIGS. 9 and 10 is part of the fixed fastener 32 of FIG. 7. The cover 62 of FIGS. 11 and 12 includes the fixed fastener 30 of FIG. 6.

While the foregoing description and drawings represent the preferred embodiments of the present invention, it will be understood that various changes and modifications may be made without departing from the spirit and scope of the present invention.

What is claimed is:

1. A structure for use in audio playback, comprising:
a pair of audio speakers each having a housing, a retractable fastener movable between a retracted position and a fully extended position, and a fixed fastener movable between a locking position and an unlocking position while the retractable fasteners are in the retracted position and one of the fixed fasteners overlaps the other of the fixed fasteners.

2. A structure as in claim 1, wherein the retractable fasteners are spring biased and the fixed fasteners are fixed against bias, the spring biased fasteners compressing associated springs to reach the retracted position from the fully extended position.

3. A structure as in claim 1, wherein each of the housings having a configuration that is of a convex shape, each of the retractable fasteners and the fixed fasteners having an outward face that conforms in shape to the convex shape while the retractable fasteners are in the fully extended position.

4. A structure as in claim 1, further comprising an audio cord extending from each of the housings and being spooled about a junction between the pair of speakers while the fasteners are in the locked condition, the junction where the one of the fixed fasteners overlaps the other of the fixed fasteners.

5. A structure as in claim 2, wherein at least one of the fixed fasteners has corners so that while both of the spring biased fasteners are compressed simultaneously, the housings may be twisted relative to each other in a rotation direction to move the fixed fasteners between the locking and unlocking conditions.

6. A structure as in claim 5, further comprising an audio cord or wire extending from each of the housings and being spooled about a junction, which is where the fixed fasteners overlap.

7. A structure as in claim 1, wherein at least one of the fixed fasteners has corners and the other of the fixed fasteners has an edge that accommodates the corners and has blocking elements arranged to block the corners when the retractable fasteners are retracted so that the housings may be rotated relative to each other at most by a quarter turn.

8. A structure as in claim 1, wherein one of the fixed fasteners has an annular configuration that encircles a void and the other of the fixed fasteners having a configuration that fits into the void.

9. A method of arranging a structure for use in audio playback, comprising moving housings of two speakers between a locking condition and an unlocking condition, the moving including moving the housing to the locking condition by aligning a retractable fastener of one of the speakers with a fixed fastener of the other of the fasteners and a fixed fastener of the one of the speakers with a retractable fastener of the other the speakers, retracting the retractable fasteners of each of the speakers simultaneously and then twisting the housings relative to each other so that fixed fasteners of the speakers engage each other, the moving including moving the housings to an unlocking condition by untwisting the housings relative to each other to clear engagement of the fixed fasteners from each other and then fully extending each of the retractable fasteners to thereby separate the speakers.

10. A method as in claim 9, further comprising moving the housings into the locking condition and spooling a common audio cord or wire of the speakers about a junction formed where the fixed fasteners are engaged with each other.

11. A method as in claim 9, further comprising blocking the housings from rotating relative to each other beyond the locking and unlocking positions.

12. A structure for audio playback, comprising:
two audio speakers each having housings and fasteners that cooperate to provide a convex configuration, the fasteners of one of the speakers being arranged to be in engagement with the fasteners of the other of the speakers to lock the housings together and being configured to release from each other by disengaging the fasteners, the fasteners of each of the speakers including one that is retractable between a retracted and fully extended position and one that is fixed against retraction.

13. A structure as in claim 12, wherein the two audio speakers have audio cord or wire that extends from the housings and is spooled about a junction, the junction being where the fasteners are in the engagement with each other.

14. A structure as in claim 12, wherein the engagement includes one of the fasteners of one of the speakers being arranged to overlap with another of the fasteners of the other of the speakers.

15. A structure as in claim 12, wherein at least one of the fixed fasteners has corners and the other of the fixed fasteners has an edge that accommodates the corners and has blocking elements arranged to block the corners when the retractable fasteners are retracted so that the housings may be rotated relative to each other at most by a quarter turn.

16. A structure as in claim 12, wherein one of the fixed fasteners has an annular configuration that encircles a void and the other of the fixed fasteners having a configuration that fits into the void.

17. A structure for audio playback, comprising:
an audio speaker having a housing and fasteners that cooperate with each other to provide a convex configuration, the fasteners being arranged to engage with counterpart fasteners of another speaker to lock and being configured to release by disengaging the fasteners, the fasteners including one that is retractable between a retracted and fully extended position and one that is fixed against retraction.

18. A structure as in claim 17, wherein one of the fasteners has an annular configuration that encircles a void, the other of the fasteners having a configuration that fits within the void.

19. A structure as in claim 18, wherein the one of the fasteners is spring biased.

20. A structure as in claim 18, where the other of the fasteners is spring biased.
